(19) United States
(12) Patent Application Publication
(10) Pub. No.: US 2013/0179200 A1
(43) Pub. Date: Jul. 11, 2013

(54) METHOD AND SYSTEM FOR DISTRIBUTING EXCESS ENTERTAINMENT INVENTORY

(71) Applicant: Tenth Caller, Inc., Portland, OR (US)

(72) Inventors: Andrew Calvin Almond Legard, Beaverton, OR (US); Zachary David Hull, Beaverton, OR (US); Jeffrey Thomas Foster, Portland, OR (US); John Eric Mazzocco, Portland, OR (US)

(73) Assignee: Tenth Caller, Inc., Portland, OR (US)

(21) Appl. No.: 13/675,899

(22) Filed: Nov. 13, 2012

Related U.S. Application Data
(60) Provisional application No. 61/559,625, filed on Nov. 14, 2011.

(51) Int. Cl. G06Q 10/02

(52) U.S. Cl. CPC G06Q 10/02
USPC 705/5

(57) ABSTRACT

A method and system for “papering the house”, i.e., distributing excess entertainment inventory, integrates with the new capabilities of social networking sites and mobile computing. First, a number of units of excess entertainment inventory are apportioned. A first user profile is generated and associated to a first user. A set of Tokens is then allocated to the first user. Next, a subset of Tokens allocated to the first user is selected as eligible to receive a portion of the excess inventory. Finally, records of the first user, the first user profile, the number of units of excess entertainment inventory, and the set of Tokens allocated to the first user are stored in a computer-readable medium.

### BACKGROUND

This invention is an improvement to the method and apparatus described in U.S. Ser. No. 09/990,101, filed Nov. 21, 2001, published as US2002/0087407A1 and incorporated herein by reference. This application claims the benefit from U.S. Provisional Patent Application No. 61/559,625, filed Nov. 14, 2011, whose contents are incorporated herein for all purposes.

Prior to the disclosure of US2002/0087407A1, there had not been a universal method for “papering the house”. In the past, filling an event with un-sold tickets involved time consuming, labor intensive, and piecemeal methods of giving away tickets to corporations, friends, radio station giveaways, and contests. The brunt of the labor fell on the shoulders of event promoters. There typically had not been a person to whom the task was delegated, and man-hours were not earmarked for the task. Instead, it was disorganized and limited by the number and type of contacts possessed by the event promoter.

Disclosed in publication US2002/0087407A1 is a method and apparatus for distributing tickets over a wide area network. The disclosure of US2002/0087407A1 provides an automated, focused process that brings more people who typically express an interest in an entertainment event to the event in a faster time frame. Revenue generated by the event increases without hurting the value of a ticket. The number of tickets given away is opaque to the average consumer, and tickets for a variety of events are distributed, from the most popular artists and teams to smaller, undiscovered talents.

As society evolves to rely on social networking sites like Facebook®, Google+®, Linkedin®, and Twitter®, coordination of activities by groups of individuals connected together in a social graph is increasingly accentuated. Thus, there is need in the marketplace to integrate the old methods of “papering the house” with the new capabilities of social networking sites.

Society also continues to rely increasingly on hand-held mobile devices as essential components of daily life. Applications built for these devices have the capacity to provide more relevant information to a user based, in part, on a determination of geographical locality. Accordingly, there is need in the market to leverage the new capabilities of mobile computing to provide an enhanced method for distributing excess perishable entertainment inventory.

### SUMMARY

Embodiments of the invention are an improved method and system for “papering the house”, i.e., distributing excess entertainment inventory. Some embodiments integrate with the new capabilities of social networking sites and mobile computing to provide a more personalized experience that fosters deep social engagement. First, a number of units of excess entertainment inventory are apportioned. A first user profile is generated and associated to a first user. A set of Tokens (described in greater detail below) is then allocated to the first user. Next, a subset of Tokens allocated to the first user is selected as eligible to receive a portion of the excess inventory. Records of the first user, the first user profile, the number of units of excess entertainment inventory, and the set of Tokens allocated to the first user are stored in a computer-readable medium. The first user bids a first portion of Tokens on a first contest to win a first portion of excess inventory. The selection of Tokens eligible to receive the first potion of excess inventory occurs at random, according to embodiments. Finally, an embodiment displays the odds of winning the first portion of excess inventory to the first user.

### BRIEF DESCRIPTION OF THE DRAWINGS

FIG. 1 is an exemplary distribution of excess entertainment inventory over the Internet and a mobile data network.

FIG. 2 depicts the exemplary server of FIG. 1, coupled to a persistent data store and running an embodiment of the invention.

FIG. 3 depicts an interaction between an embodiment and an interoperable social networking service.

FIG. 4 is a flow diagram illustrating an interaction with an embodiment as experienced by a user.

FIG. 5 is a flow diagram illustrating an interaction with an embodiment as experienced by a system administrator.

FIG. 6 is an exemplary calendar layer showing entertainment events for which a first user participates in contests for excess inventory.

FIG. 7 is an exemplary calendar layer showing entertainment events for which a second user participates in contests for excess inventory.

FIG. 8 is an exemplary calendar showing the layer of FIG. 7 superimposed on the layer of FIG. 6.

FIG. 9 is an exemplary calendar showing layers of FIG. 6, FIG. 7, and a layer of promotional events superimposed on one another.

FIG. 10 shows the use of location services in mobile devices according to an embodiment.

### DETAILED DESCRIPTION

Embodiments of the invention successfully promote live event information and distribute excess entertainment event inventory without diminishing the public's perceived value of access to the event or the brand of the artist. This is accomplished by aggregating live event audiences and provides: (a) consolidated, comprehensive, live event information in a user's geographic area while providing the user the option to display only the events that may be of interest; (b) simultaneously offering the opportunity to win tickets to each of the live events displayed; and (c) instantly notifying winners via electronic communication sent directly to their individual computers or hand held mobile devices, based on proximity to the event and a previously entered preference for attending the event.

### Tangible Embodiments

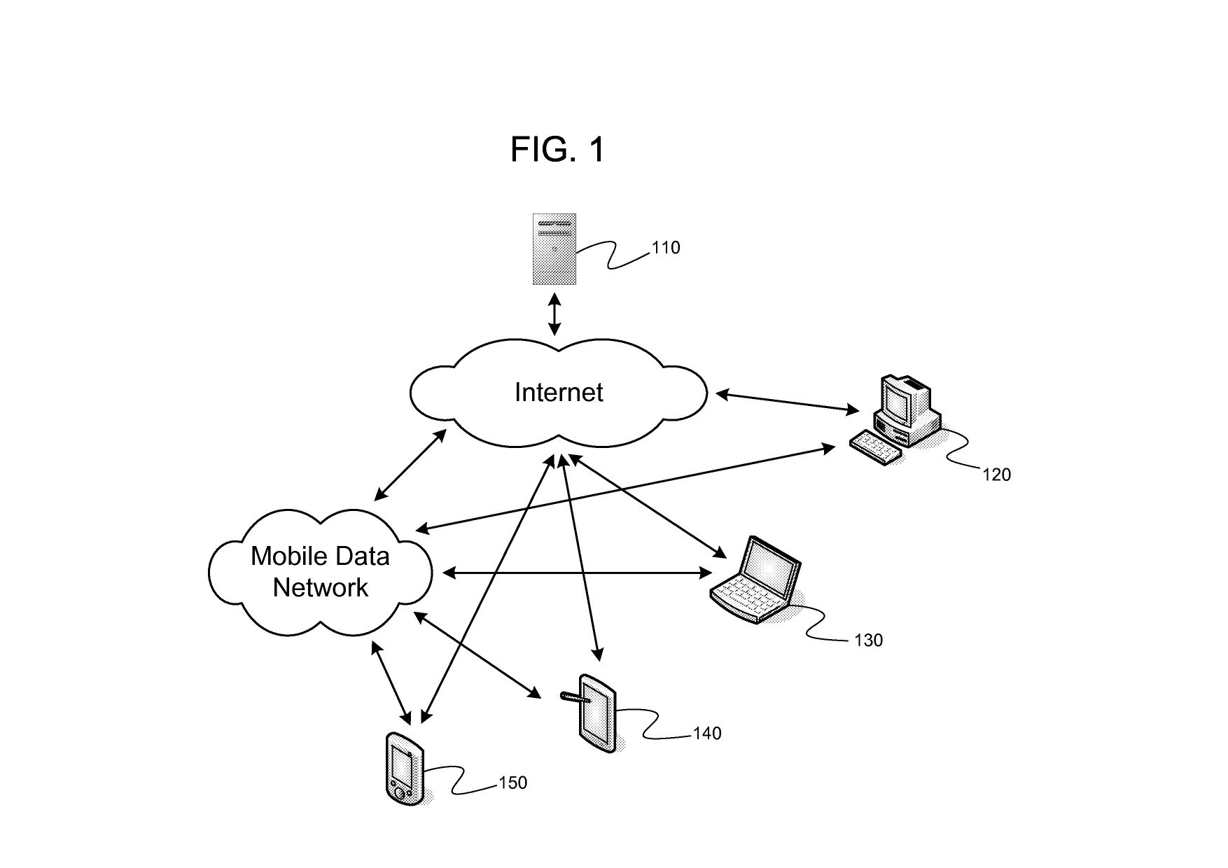

FIG. 1 shows an exemplary manner of distributing excess entertainment inventory. Server 110 communicates with desktop computer 120, laptop computer 130, tablet 140, and handheld device 150 over standard communication protocols, such as HTTP, TCP/IP, or any other packet-based mechanism. Server 110 may also communicate with any of the aforementioned devices through a mobile data network, such as LTE, CDMA, WiMAX (IEEE 802.16), etc. Embodiments of the invention may run natively by invoking the application programming interface (API) of the operating systems of devices 120-150, or they may be executed within the Internet browsers available to each of these devices. In either case, requests and responses between server 110 and devices 120-150 are shuttled across the Internet, the mobile data network, or both.

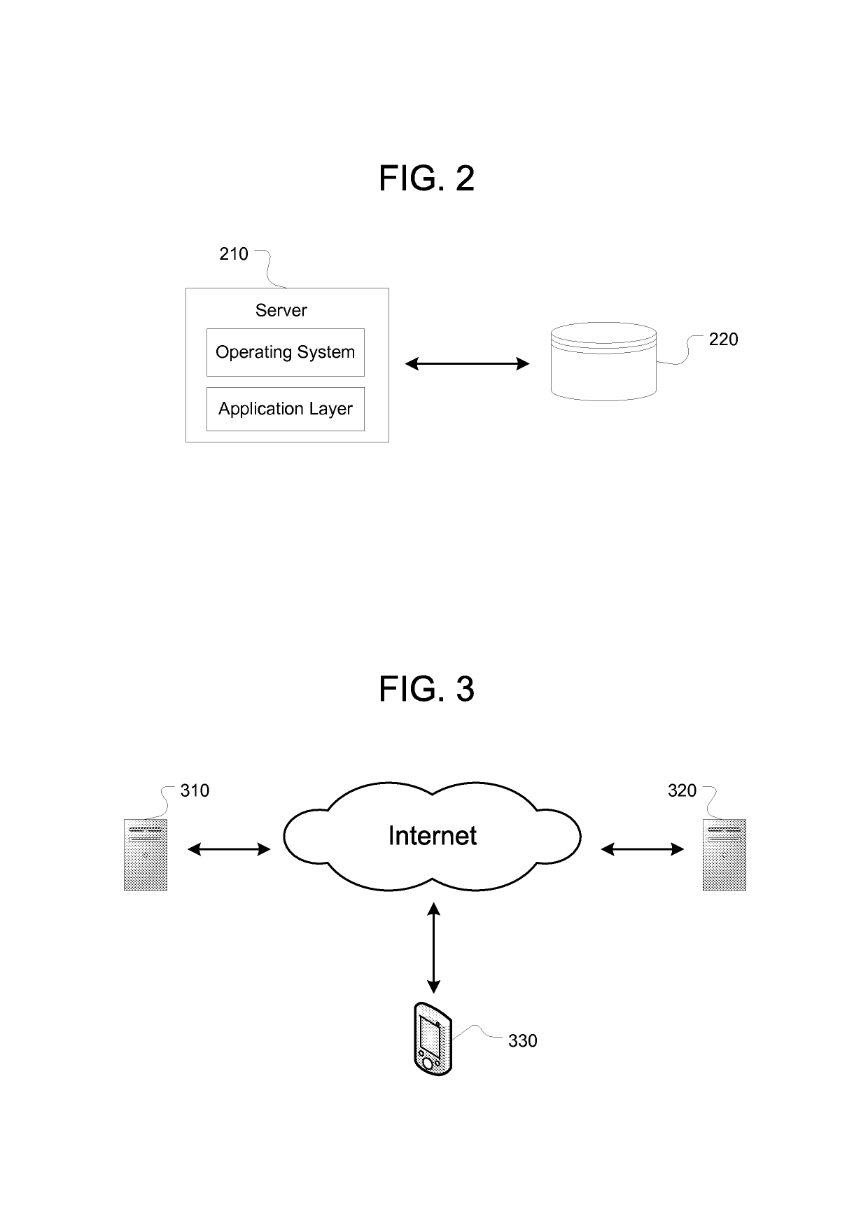

FIG. 2 depicts an exemplary server, in communication a persistent data store, running an embodiment of the invention. Server 210 is typically assembled from a central processing unit, system bus, volatile and non-volatile memory, and persistent file storage. An operating system executes on this hardware and dedicates a segment of memory space to applications. Embodiments of the invention execute in this application layer. Server 210 may also be coupled to a data store 220, which may take the form of a relational database management system (RDBMS), a NoSQL database management system, or any other persistent data store. While depicted communicating to an external data store 220 over a network, server 210 may also communicate with such a data store 220 internally, running in the application layer of server 210.

### Token-Based Contest

Aspects of the invention maintain the audience's perceived value of a ticket by always maintaining a minimum quantity of inventory available. When there is a need to paper the house, inventory is increased nearly instantaneously without alerting the users to the influx of unsold tickets that are given away. By shielding the glut of ticket inventory from the users, the perceived value of tickets is preserved publicly, which benefits ticket sales on the day of the event.

Embodiments of the invention improve upon past methods of papering the house by providing a quickly scalable method to fill a venue with an audience electronically. Users create logins to a service or download an application, and they participate in event giveaways within minutes. In doing so, event revenue increases from back-end sales of concessions, parking, and related attendance fees, goods, and services that would normally be lost.

Users, after creating a profile or using a profile associated with a social networking site, are allotted a bundle of Tokens according to an embodiment. Tokens are fungible. They can be expended by a user, traded between users, and donated from one user to another. Preferably, they have uniform value, and no one Token is unlike any other Token. While given the name “Token”, a Token may have any number of names consistent with the manner and spirit of the concept disclosed herein. Moreover, it should not be used as a limiting term, but rather as the nucleus of an embodiment that may take many forms.

According to an embodiment, a purpose for Tokens is for users to allocate towards a contest, the result of which affects a user's chances of winning a portion of excess entertainment inventory. Tokens are awarded to users based on the amount of engagement they have with the embodiment. For example, a bundle of twenty Tokens may be awarded to a user upon initial creation of a profile or upon the first authentication with a social networking site and its associated profile. Successive returning visits, separated by a twenty-four hour timespan, may result in additional awards of ten Tokens in another embodiment. A return visit, separated by an eight hour timespan, may result in an award of five tokens in yet another embodiment. Each Token is associated to one user.

A user accumulates a bank of Tokens over time, a portion or the entirety of which may be allocated to a contest for excess entertainment inventory, according to embodiments. Contest results are determined by random lottery from a pool of Tokens owned by one or more users. A subset of Tokens is selected from the pool, which represents the set of winners. A user who allocates an increasing number of Tokens to a contest increases that user's chances of winning excess inventory. Furthermore, repeated and frequent engagement with the embodiment facilitates the ability to build a large trove of Tokens, also increasing a user's chances to win, depending upon how they are allocated.

Tokens provide a catalyst for a number of interesting embodiments. When combined with access to a user's social graph, they lead to even greater social engagement. Coordination between members of a social graph naturally entails game-play strategies that add to the excitement of contest participation.

### Social Integration

An embodiment of the invention uses authentication protocols common to social networking sites for user login. One such authentication protocol is OAuth 2.0, used by both Facebook® and Google+® and promulgated by the Internet Engineering Task Force (IETF). The embodiment is registered with a social network to generate unique values known only to the social network and the embodiment. Some of these are an application ID and a shared secret. When a user of the embodiment elects to login using a profile associated with a social network, the attempted login will provoke an OAuth dialogue that requires the user to submit authentication credentials, such as a user name and password. Assuming authentication with the OAuth protocol is successful, the OAuth dialogue disappears, returning the user to the embodiment. An alternate embodiment may be confined to a restricted scope of access privileges if the social network allows the user to vary that scope for a duration of the OAuth session.

A successful login provides the embodiment with an authentication token, as defined by the protocol, that grants access to the user's social profile through an API. Using standard Internet protocols, the embodiment invokes a service call to an endpoint that provides information about the user. As seen in FIG. 3, a server 310 running the embodiment issues requests to and fields responses from another server 320 running an instance of the social networking application. This includes the OAuth handshake mentioned above and use of the API described below. Device 330 may also be loaded with scripts from server 310 that directly invoke services published by social server 320. In this respect, not all communication with social server 320 needs to transit through server 310.

Within a given scope of access privileges, information made available about the user can include the graph of social connections to other individuals in his or her network, music preferences, and feeds of postings in various forums. Another embodiment of the invention may allow the user to concurrently login to multiple social networking providers, such as Facebook®, Google+®, Linkedin®, and Twitter®. Data from multiple social networks can then be harvested, aggregated, and incorporated into the embodiment to enhance the user experience.

### User and Administrator Experience

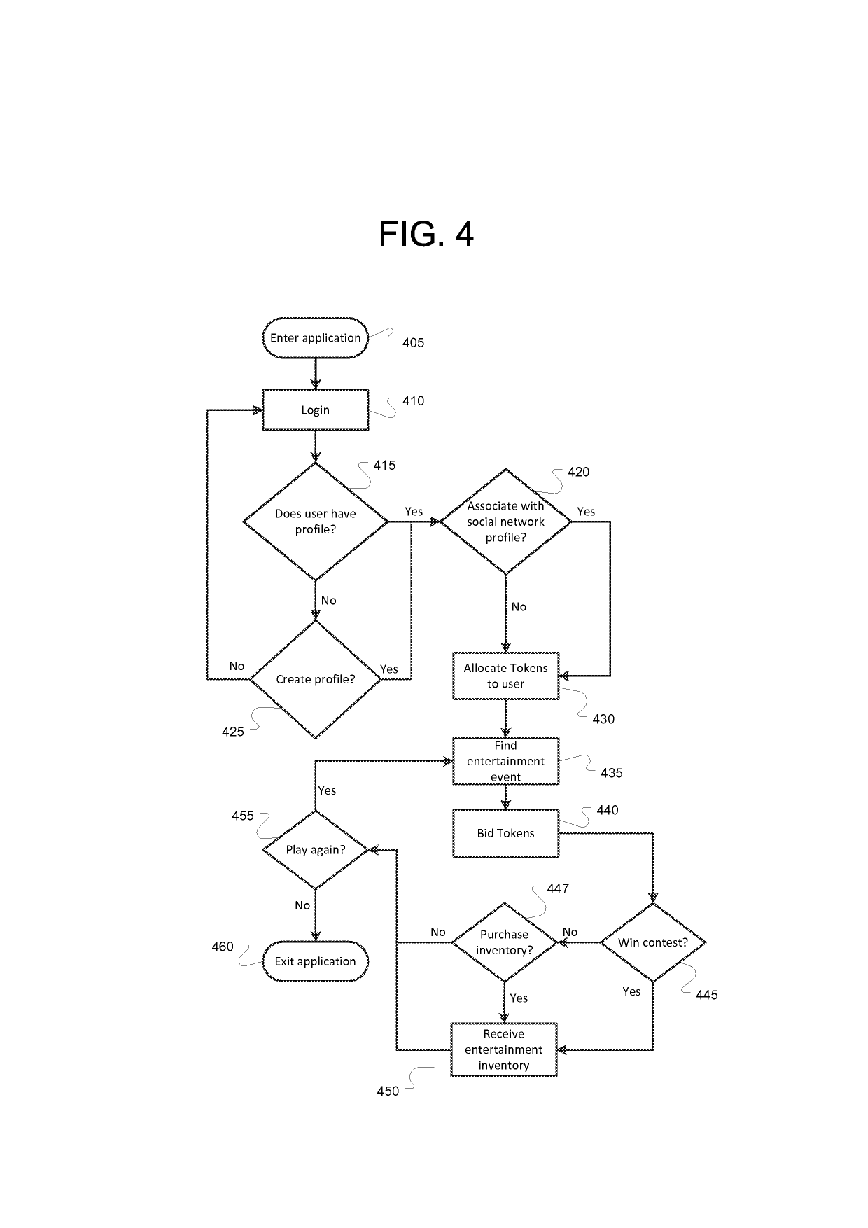

FIG. 4 illustrates a user experience according to embodiments. A user enters the application 405 and attempts to login 410. A prerequisite to successful login is the existence of a user profile 415. If the user is not associated with a profile, he is prompted to create a profile 425. Should the user refuse to create a profile, he is directed back to the login prompt 410.

Once a user profile is created, the user is asked at step 420 whether he would like to associate that profile with one or more of his profiles for social networking applications to which he is affiliated. Regardless of the answer, the user is allocated 430 a number of Tokens. The number of Tokens allocated to the user may be elevated when associating a social networking profile with the embodiment, as compared to creation of a profile not associated with social networking applications. This is one of many potential incentives to engage in social activities as embodied in step 430.

Once the user has a bank of Tokens, at step 435 he searches for entertainment events that are of interest. These may include events for which there is excess inventory and a contest to win a portion of that inventory. In an embodiment, odds of winning the excess inventory are displayed near the event information. Events revealed in the search may also include sponsored search results for which there is no excess inventory. Search results for sponsored events and events associated with a contest are tailored, according to some embodiments, to the user who is logged in based on the profile associated with the user. According to other embodiments, this is also based on one or more social networking profiles associated with the user. Preferences are gleaned from content retrieved from a social networking application, such as status streams, affirmations of content from other portions of a social network, and content that is re-posted from other regions of the Internet, including other social networking applications.

For events with excess inventory, the user bids all or a portion of his bank of Tokens on the contest. In some embodiments, winning users are selected at step 445 from the pool of Tokens that have been wagered on the contest at random. A deadline may be imposed on the contest to allow sufficient time for a suitable number of users to participate. After the deadline expires, which could range from minutes to days, the user is notified that he or she is a winning contestant. Notification may take a number of forms, but includes notice by message board on an embodiment or through email. The notification includes instructions 450 for the time, place, and manner of receiving the excess inventory. For example, an email notice may include a link to a printable e-ticket or a QR code (two dimensional bar code) delivered to a mobile device that can be presented for admission to the event.

After the contest for an entertainment event 445 concludes, the user can elect to participate in another contest 455. The hunt for events of interest to the user begins anew at step 435, and participation in the contest 440-450 is repeated. In alternate embodiments, a user need not wait until he has been notified as to whether he has won at step 445 in order to play again at step 455. Multiple bids 440 on multiple contests 445 may occur simultaneously. A determination as to whether the user is eligible to receive inventory 450 is made, in part, on whether the user has been randomly selected for two or more events that have mutually exclusive dates and times. Eligibility, in this case, is a prerequisite to determining whether a user has won the contest. Once the user has exhausted the allocation of Tokens in his possession, or no longer finds entertainment events of interest to him, he exits the application at step 460. Lastly, a separate embodiment provides a user the option to purchase the inventory 447 if he does not win the contest. This last option may also be provided, in another embodiment, to winning contestants as well.

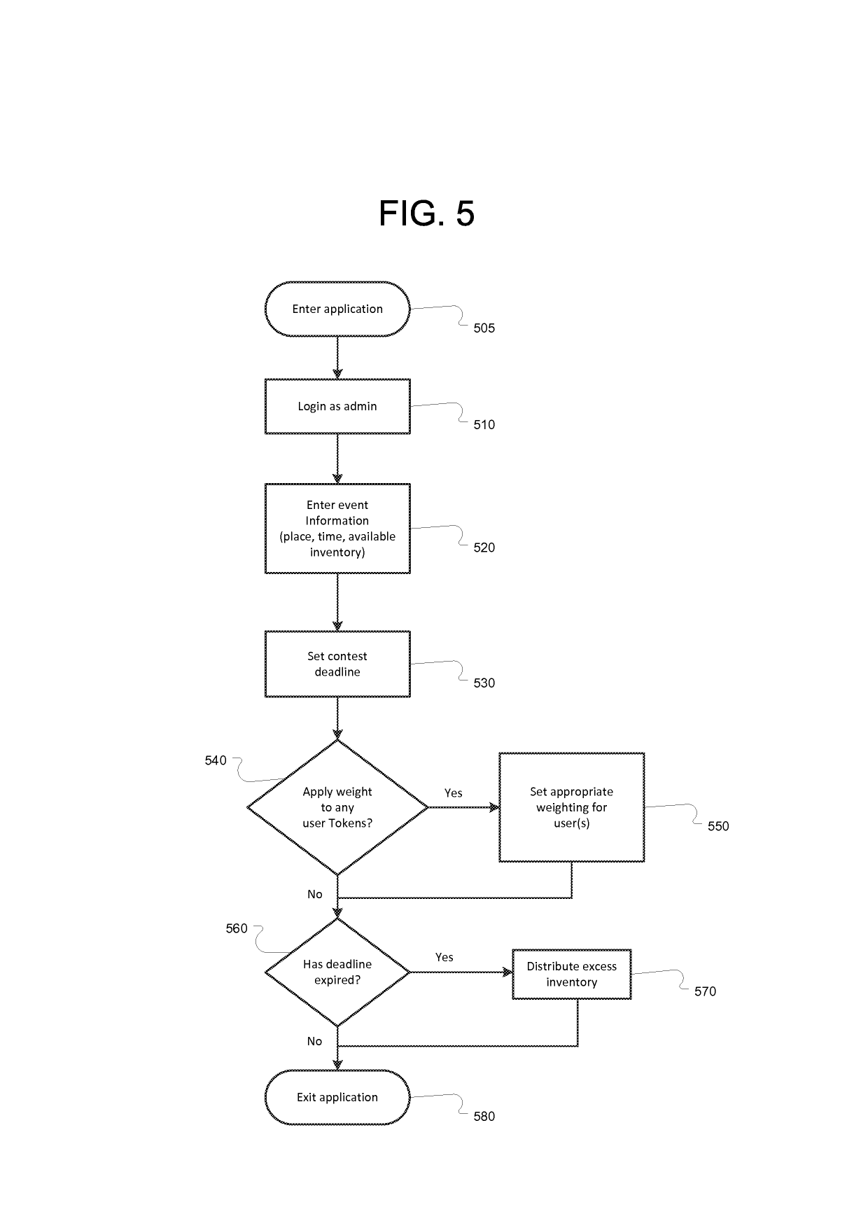

FIG. 5 illustrates an experience for an administrator of an embodiment. An administrator enters the application 505 and logs in with administrative credentials 510. He then enters information 520 for an event that has excess inventory, which includes the time, place, and amount of inventory available. In some embodiments, this is performed by an event promoter, while in others, it is an automated service. Similar to FIG. 3, an embodiment may communicate with another server configured to automate the sale or vending of tickets to events. Such a server may relate, by service call, the requisite details for excess inventory that is to be distributed. After data about the event has been entered, a deadline 530 is set for the contest. Again, this may be determined manually or in automated fashion.

As will be discussed later, an embodiment applies weights 550 to Tokens so as to affect the probability of winning a contest. After it is determined that a weight is to be applied 540, an administrator examines contests that have already expired 560 after deadline. Once again, this determination may be made manually by an administrator or by automated process. For all contests that have ended, excess inventory is distributed at step 570. If the administrator has physical possession of the excess inventory, this may entail printing address labels and mailing the inventory to the winning contestants. It may also entail supplanting this manual process with an automated process. In an alternate embodiment, QR codes (two-dimensional bar codes) can be distributed at step 570 to mobile devices immediately upon expiration of the contest deadline. An administrator may then exit 580 the application.

### Layered Calendar

An embodiment of the invention uses the graph of social connections and the information available within that graph to personalize the user experience. The social graph is also used in other embodiments of the invention to enhance game-play. Components of the personalized experience include generating targeted ads based on data harvested from the user's social graph, creating a layered event calendar that coincides with calendars of other individuals in the graph, and generating strategies for the allocation and distribution of Tokens used to win excess entertainment inventory, which may take the form of tickets to live entertainment events or access credentials to live entertainment events that are streamed over electronic media.

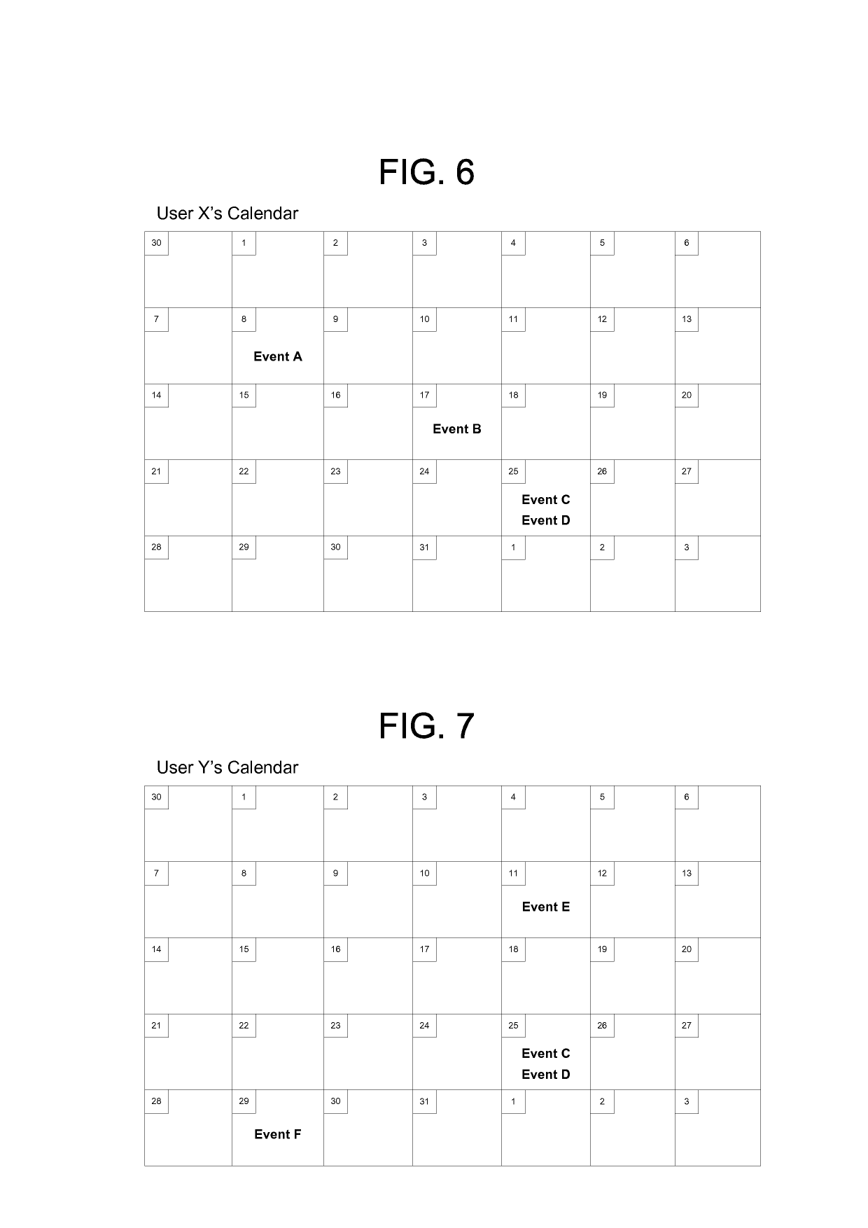

As shown in FIGS. 6-8, an embodiment of a layered calendar will present a first layer of entertainment events that interest the user in some manner or another. This may be a display of events for which the user has allocated a portion of available Tokens in an attempt to win a contest for a portion of entertainment inventory. The display may also include a collection of events for which the user would like to broadcast a tentative interest to his or her social graph. The broadcast may garner a collective decision to attend the event among a subset of individuals within that graph.

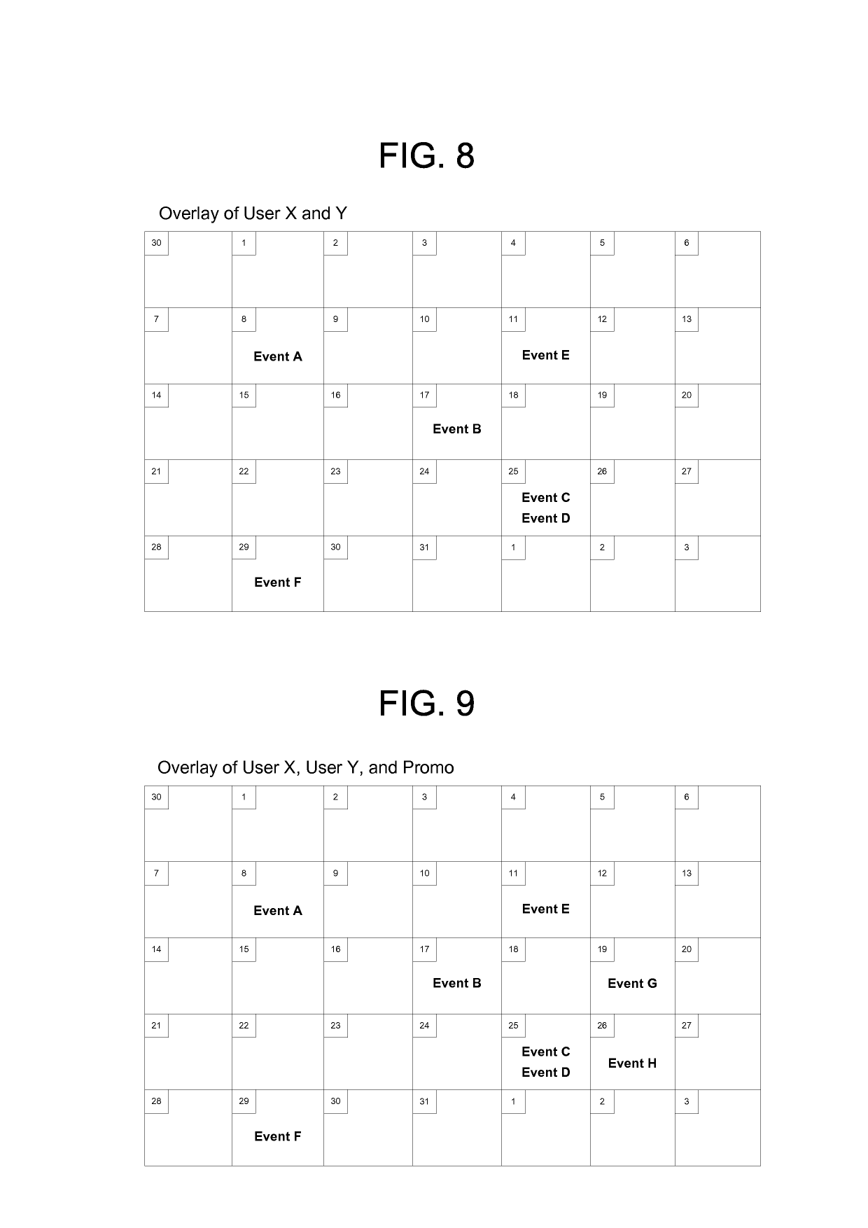

In FIG. 6, User X expresses interest in inventory for Events A-D. Of these, User X has bid on all events except for Event B, which is only an expression of interest to be broadcast to other members of User X's social graph. User Y, in FIG. 7, expresses interest in Events D-F. Of these, User Y bids on events C and D, which are events of mutual interest with User X. FIG. 8 shows a view of User X's calendar, as seen by her, with User Y's interests superimposed on hers. From this view, User X is able to discern her mutual interest in Events C and D.

As illustrated in FIG. 9, a third layer of the calendar embodiment, which may be superimposed upon one or more other layers of the calendar, includes the display of promotional events. These may be sponsored events that gain prominence in the calendar according to an agreement for preferential status. Prominence in the calendar may also be chosen on the basis of the amount of inventory available for a given event and a calculation of the cost-benefit analysis that is most favorable to moving a quantity of that inventory as compared to inventory for other events. In FIG. 9, Events G and H are promoted and displayed to Users A and B as a mandatory or optional layer to their calendars.

### Game-Play

Combining the social integration aspects of the invention with the aspect that employs Tokens as the fulcrum of contests produces interesting game-play. This game-play, in an embodiment, results in group behavior that can be coordinated between individuals whom are interconnected through their social graphs.

For example, one embodiment allows users to trade or donate their Tokens to one another. This may be useful for an event that User X and User Y both wish to attend. They learn of the mutual wish to attend Events C and D through their layered calendars, disclosed above. User X has a very large quantity of Tokens, but User Y has few. By donating a portion of her Tokens to User Y, User X is able increase User Y's chances of winning one of the contests. If the allocation of Tokens by User X and User Y to the events significantly outnumbers the allocations of other users, User X has a greater likelihood of attending the desired event without severely affecting her chances of winning while also attending the event with preferred accompaniment.

In another embodiment, User Y requests a trade for Tokens from User X. User X possesses a surplus, while User Y possesses a meager number. User X may trade her surplus to User Y upon the conditional promise that if User Y should have a surplus in the future, he will make the return trade of Tokens back to User X when she is in need. This results in a successful barter and allows each user to seize opportunities that would otherwise be unavailable. Bartering need not be restricted to exchanges to Tokens. Another embodiment allows Users X and Y to exchange inventory won from contest.

These bartering and sharing activities may be encouraged in another embodiment. Additional Tokens are awarded to the party who shares, donates, or trades Tokens to another user. Rather than incurring a transaction cost, one or both parties may reap a transaction benefit. Doing so encourages participants to socially engage, using both the embodiment and the social network as the medium of engagement.

Other methods of fostering social engagement are possible. Inviting other members of a social graph, who are not yet participants of the embodiment, are rewarded with an additional allocation of Tokens. Confirmation that a user attended an event results in an award of more Tokens. Users identifying themselves as members of a group that attended an event together results in an even greater award of Tokens. Listening to or viewing an artist, verified either through purchase of media or through a streaming internet service, results in an award of Tokens that may be allocated to an event featuring that artist. Verification may occur with the use of a confirmation code or through an invocation of a service that is interoperable with a vendor or provider that distributes performances by the artist.

Leader-boards also foster engagement with an embodiment of the invention. A user who has allocated the greatest number of Tokens to events, as compared to the rest of the community interacting with the embodiment, is displayed as the “Top Bidder” on the leader board. A user who has won the most contests may be displayed as the “Top Winner” on the leader board, and a user who has traded the most Tokens may be displayed as “Top Trader”. A user who has lost the greatest number of contests may be displayed as the “Most Deserving,” and an embodiment may weigh the probability of winning the next contest more heavily in his favor so as to prevent discouragement. Users with a deep level of engagement, as shown by the leader board, may be granted access to exclusive contests that are not accessible to users with a more shallow level of engagement in a separate embodiment.

### Application to Mobile Computing

The embodiments disclosed above are further enhanced when applied to advancements in mobile computing. Mobile devices allow embodiments to be built against native API's for the Apple iPhone®, Google Android®, and potentially for nascent mobile technologies like Google Glass®. Consequently, embodiments are distributed through application stores, such as the Apple App Store® and Google Play®, which may be downloaded freely to the device or purchased at nominal cost. These devices also allow embodiments of the invention to be accessed through an internet browser in a manner similar to that of desktop or laptop computing.

It is common for mobile devices like those mentioned above to have location services, such as access to the global positioning system (GPS), triangulation of geographic position through nodes in a wireless network, or identification of location based on internet protocol (IP) address. An embodiment invokes location services to identify the geographic position of a user. Entertainment events with excess inventory and within that user's immediate proximity are displayed on a map.

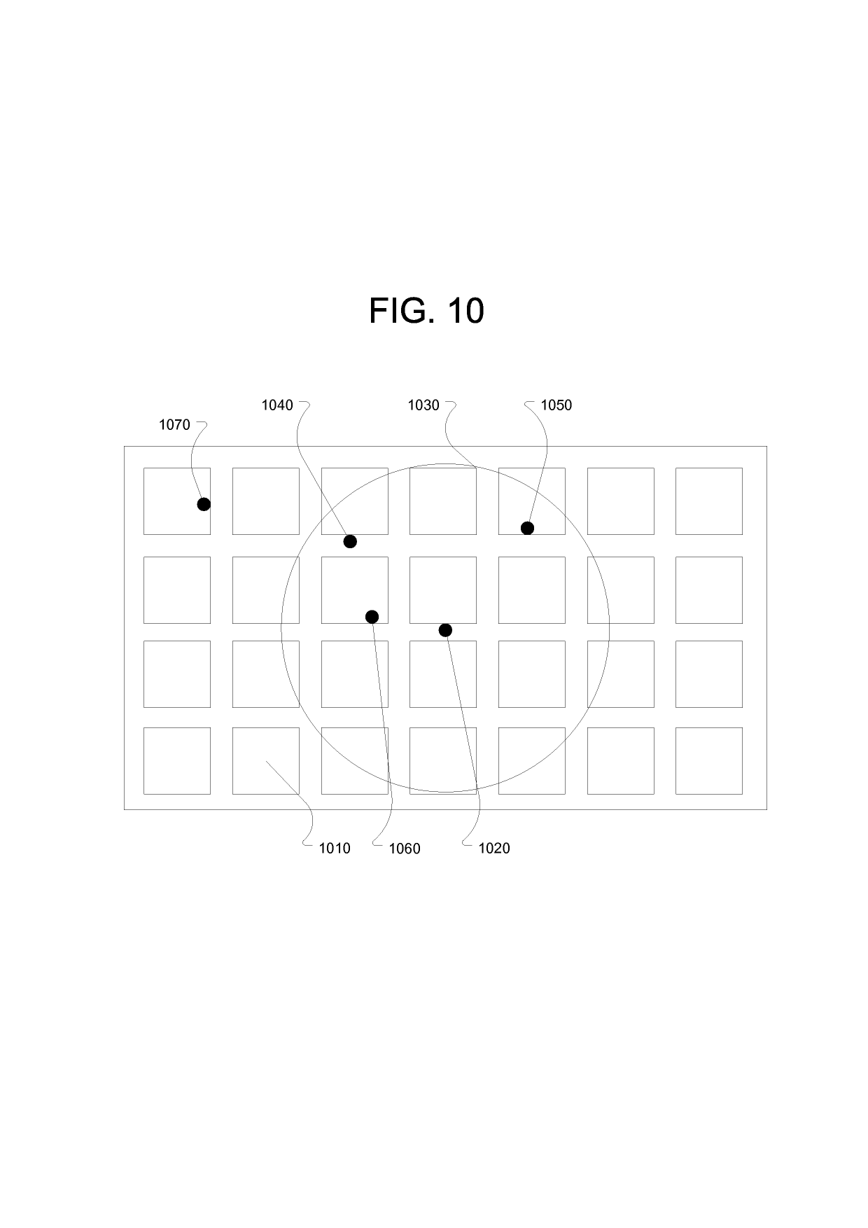

As seen in FIG. 10, a map of User X′s location 1020 shows a grid with city blocks 1010. User X configures the mobile application running on her phone to search for entertainment events within two and a half city blocks of her location, as determined by GPS. This range is depicted by the circle radiating 1030 from her location. Three events 1050-1070 are nearby, but only two, 1050 and 1060, satisfy her search criteria. She allocates a number of Tokens she has banked over time to each event, and she wins tickets to one. QR codes are delivered to her phone, which grant her admittance to the event. Within minutes of inquiring about the availability of shows and tickets, she attends a concert.

Alternate embodiments of the invention allow User X to view the calendars, disclosed above, of individuals in her social graph that express a similar interest in attending a concert that evening. The embodiment calculates the coinciding proximity of each user to one another and the events with excess inventory within the same proximity. That result is displayed to each user, and they form a game-play strategy to win a contest for the displayed events based, in part, on mutual interests as determined in FIGS. 6-8. In the case of FIG. 10, User Y 1040 is within User X′s 1020 proximity, and the event most sensible for each of them to attend is Event C 1060. They can allocate their tokens to Event C 1060 and increase their chances rather than split their chances between Event C 1060 and Event D 1070.

As disclosed above, embodiments of the invention aggregate live event audiences and provide: (a) consolidated, comprehensive, live event information in a user's geographic area while providing the user the option to display only the events that may be of interest; (b) simultaneously offer the opportunity to win tickets to each of the live events displayed; and (c) instantly notify winners via electronic communication sent directly to their individual computers or hand held mobile devices, based on proximity to the event and a previously entered preference for attending the event. These embodiments satisfy the need to integrate the old methods of “papering the house” with the new capabilities of social networking sites. They also meet the need to leverage the new capabilities of mobile computing and provide an enhanced method for distributing excess perishable entertainment inventory.

Having described and illustrated the principles of the invention in a preferred embodiment thereof, it should be apparent that the invention can be modified in arrangement and detail without departing from such principles. We claim all modifications and variation coming within the spirit and scope of the following claims.

We claim:

1. A method for distributing excess entertainment inventory, the method comprising:
apportioning a number of units of excess entertainment inventory;
generating a first user profile and associating a first user to the first profile;
allocating a set of Tokens to the first user;
selecting a subset of Tokens allocated to the first user as eligible to receive a portion of the excess inventory; and
storing a record of the first user, the first user profile, the number of units of excess entertainment inventory, and the set of Tokens allocated to the first user in a computer-readable medium.

2. The method of claim 1, comprising allocating the set of Tokens to the first user upon creation of the first user profile.

3. The method of claim 1, comprising generating the first user profile by associating the first user with a second profile retrieved from an interoperable social networking service.

4. The method of claim 1, comprising selecting the subset of Tokens eligible to receive a first portion of excess inventory by bidding a first portion of Tokens by the first user on a first contest to win the excess inventory.

5. The method of claim 4, comprising displaying odds of winning the first portion of excess inventory.

6. The method of claim 4, comprising selecting the subset of Tokens eligible to receive the first portion of the excess inventory at random.

7. The method of claim 4, comprising selecting the subset of Tokens eligible to receive the first portion of the excess inventory by weighting a probability of winning the first contest in favor of the first user.

8. The method of claim 4, comprising bidding a second portion of Tokens, by the first user, on a second contest to win a second portion of excess inventory.

9. The method of claim 4, comprising bidding a multiplicity of portions of Tokens on a multiplicity of contests to win a multiplicity of portions of excess inventory.

10. The method of claim 1, comprising transferring Tokens from the first user to a second user.

11. The method of claim 9, comprising allocating an additional set of Tokens to the first user as a consequence of transferring Tokens to the second user.

12. The method of claim 1, comprising inviting a member of the first user's social graph, as determined from an interoperable social networking service, to generate a second user profile and associate the second profile with the member.

13. The method of claim 11, comprising allocating another set of Tokens to the first user as a consequence of the invitation.

14. The method of claim 1, comprising allocating another set of Tokens to the first user as a consequence of one of:
interacting with an artist through an interoperable social networking service;
consuming entertainment produced by the artist; and
attending an entertainment event for which there is excess inventory.

15. The method of claim 1, comprising invoking a location service made available by a mobile device to locate entertainment events in the first user's proximity.

16. The method of claim 14, comprising locating entertainment events that are in proximity to members of the first user's social graph.

17. The method of claim 1, comprising expressing interest, by the first user, in events for which there is excess entertainment inventory and viewing the interests of members of the first user's social graph in events for which there is excess entertainment inventory.

18. A system for distributing excess entertainment inventory, comprising:
a server means, comprised of an operating system and application layer, for executing an application;
a network means for communicating with mobile devices, desktop devices, and servers using standard protocols;
a first application means for apportioning a number of units of excess entertainment inventory;
a second application means for generating a first user profile and associating a first user to the first profile;
a third application means for allocating a set of Tokens to the first user;
a fourth application means for selecting a subset of Tokens allocated to the first user as eligible to receive a portion of the excess inventory;
a persistent data store means for storing a record of the first user, the first user profile, the number of units of excess entertainment inventory, and the set of Tokens allocated to the first user;
a fifth application means for selecting the subset of Tokens eligible to receive a first portion of excess inventory by bidding a first portion of Tokens by the first user on a first contest to win the excess inventory; and
a sixth application means for selecting the subset of Tokens eligible to receive the first portion of the excess inventory at random.

19. The system of claim 18, comprising a seventh application means for displaying odds of winning the first portion of excess inventory.
